(19) United States
(12) Patent Application Publication
(10) Pub. No.: US 2006/0129563 A1
(43) Pub. Date: Jun. 15, 2006

(54) Systems and methods to provide and bill for internet access

(75) Inventors: Michael Phillips, Brooklyn, NY (US); Colin Hendricks, Houston, TX (US)

Correspondence Address: Hickman Patent Law Offices, PO Box 2202, Bellaire, TX, 77401, US

(73) Assignee: Icor Systems, LLC

(21) Appl. No.: 11/297,984

(22) Filed: Dec. 10, 2005

Related U.S. Application Data
(60) Provisional application No. 60/635,024, filed on Dec. 10, 2004.

(51) Int. Cl. G06F 17/30

(52) U.S. Cl. 707/10

(57) ABSTRACT

A method of providing metered Internet access, includes a user sits down at a client computer, the user chooses a payment method, the user's payment method is validated by a remote transaction server, and the user is provided access to the Internet. A method of providing metered Internet access at public libraries based on configurable time limits and reservations, includes a user sits down at a client computer, the user enters their library card number, the user's number is verified against the library's library card database and against a remote transaction server that verifies the number of minutes allotted to that user, and the user is provided access to the Internet.

This application claims priority to U.S. Provisional Application 60/635,024, filed Dec. 10, 2004. U.S. Provisional Application 60/635,024 is herein incorporated by reference in its entirety.

### FIELD

The present disclosure is related to provisioning, monitoring and/or billing for access to the Web from a PC.

### BACKGROUND

Metered access to the Web from a PC is a service traditionally provided by proprietors of dedicated locations primarily oriented around providing Web access to their customers. These proprietor locations are typically referred to as “Internet cafés”, and they have enjoyed success in most major metropolitan areas around the world. Internet cafés emerged as the dominant retail format with regard to metered access to the Web for two major reasons:

Large numbers of machines in one location helped to defray the historically expensive telecommunications cost, such as that associated with T-1 or fractional T-1 services, that high-speed Web access required.

Monitoring and billing for metered Web access historically required either 1) on-site personnel, or 2) local software that could run on separate machines located on the same network segment as the PCs providing metered Web access. Such overhead, in terms of either people or technology, could be defrayed over large numbers of machines at an Internet café.

Small public libraries also provide free access to the Internet from completely unregulated PCs. These libraries cannot afford the complex software used at larger libraries to manage PC configuration and meter use of the PCs.

The widespread availability of Digital Subscriber Line (DSL) Service and Digital Cable, from traditional telecommunications carriers and cable companies, respectively, has dramatically reduced the costs associated with providing high-speed Web access.

However, the high overhead associated with monitoring and billing for the service has discouraged the proliferation of metered Web access at non-dedicated proprietor locations and at small libraries. There is a need in the art for a monitoring and billing system for providing metered Web access.

### SUMMARY

A method of providing metered Internet access, includes a user sits down at a client computer, the user chooses a payment method, the user's payment method is validated by a remote transaction server, and the user is provided access to the Internet.

A method of providing metered Internet access at public libraries based on configurable time limits and reservations, includes a user sits down at a client computer, the user enters their library card number, the user's number is verified against the library's library card database and against a remote transaction server that verifies the number of minutes allotted to that user, and the user is provided access to the Internet.

### BRIEF DESCRIPTION OF THE DRAWINGS

FIG. 1 illustrates a Web access system;

FIG. 2 illustrates a method for providing Web access;

FIG. 3 illustrates a method for providing Web access;

FIG. 4 illustrates a Web access system;

FIG. 5 illustrates a method for updating Web access software;

FIG. 6 illustrates client software;

FIG. 7 illustrates a system for providing Internet access;

FIG. 8 illustrates a method for providing Internet access; and

FIG. 9 illustrates a method for providing Internet access.

### DETAILED DESCRIPTION

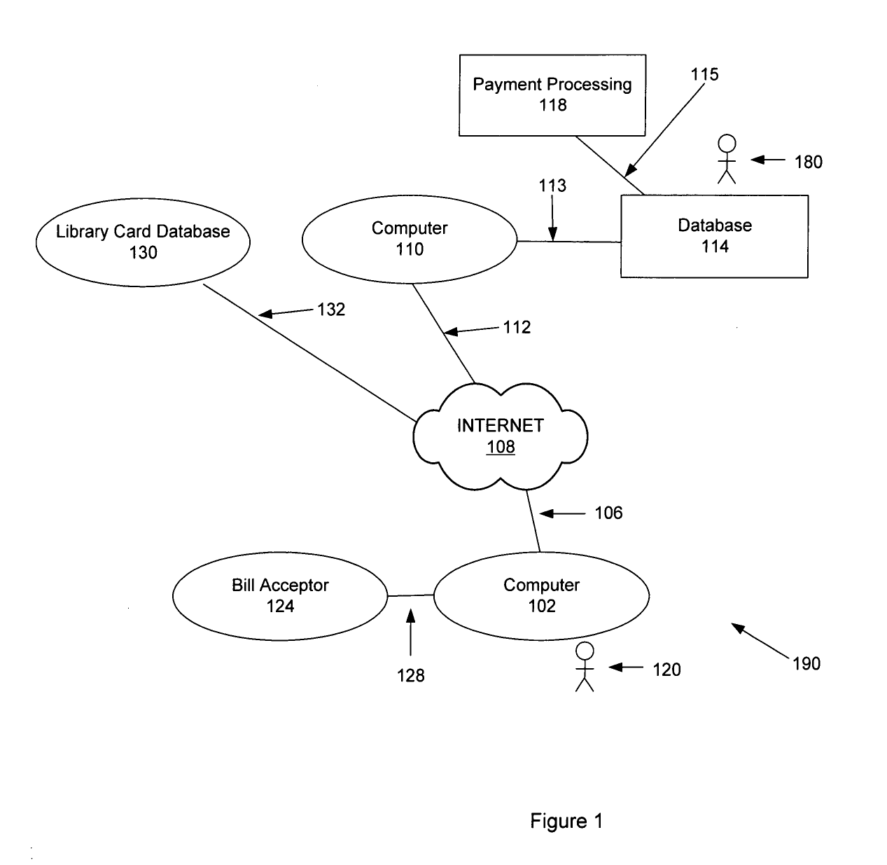

In one embodiment, as illustrated in FIG. 1, system 190 for connecting a user to the Internet is illustrated. System 190 includes user 120 at computer 102 coupled to Internet 108 by connection 106, and optionally coupled to cash bill acceptor 124 by connection 128. System 190 also includes second computer 110 coupled to Internet 108 by connection 112. Second computer 110 is also coupled to database 114 by connection 113. Payment processing system 118 is coupled to database 114 by connection 115. System 190 also includes Library Card Database 130 which is coupled to the Internet 108 by connection 132.

System 190 may be used to sell Internet access to a user in a public place where computer 102 is installed. Computer 110 and/or database 114 contain a list of authorized users, for example user 120, and selectively allows them access to Internet 108 by computer 102. User 120 enters access information into computer 102, which is passed to computer 110, and queried against database 114. If necessary, cash payment may be provided in bill acceptor 124 or a credit card may be processed by payment processing system 118.

Internet provider 180 manages computer 110, database 114, and optionally payment processing system 118 remotely from computer 102 in order to sell Internet access to users, for example user 120, located at computers, for example computer 102, provided at a separate geographic location and where computer 110 and/or database 114 are located, for example at least about 5 miles, at least about 10 miles, at least about 50 miles, at least about 100 miles, at least about 1000 miles, or at least about 2500 miles.

In some embodiments, system 190 may also be used to regulate use of Computer 102 in a public library setting. User 120 may not be charged per minute but rather may be limited to a certain number of minutes per a certain interval, usually one day. Computer 102 connects to Library Card Database 130 and to Computer 110 to query if the user should be allowed access to the Internet 108.

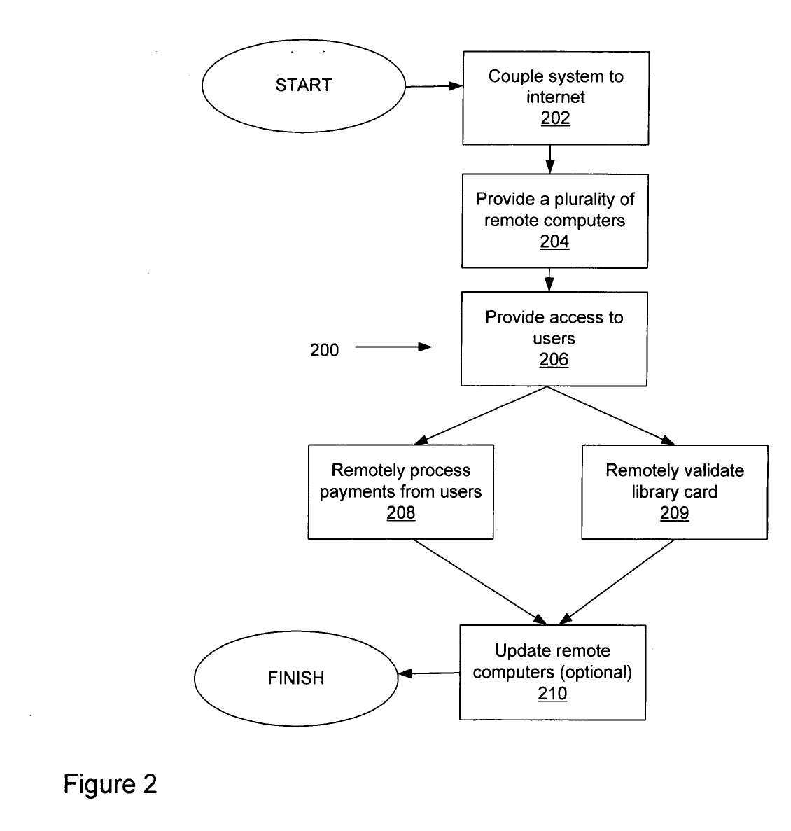

Referring now to FIG. 2, in another embodiment, a method of using system 190 is illustrated. System 190 is coupled to Internet 108 at 202. A plurality of remote computers, for example computer 102, are provided and connected to Internet 108 at 204. Access is provided to one or more users, for example user 120, at 206. In one embodiment, each user may pay for Internet access at the remote computer. At 208, payments from users are processed remotely from the users, for example using payment processing system 118. In one embodiment, at 210, the optional step of updating the remote computers is provided, for example updating computer 102 with information from computer 110.

In another embodiment, if System 190 is in use at a public library, the user's library information is validated against the Library Card Database 130 and the access rules defined with information on computer 110. If the user has a valid library card and has not used his allotted time for the current interval, access may be granted.

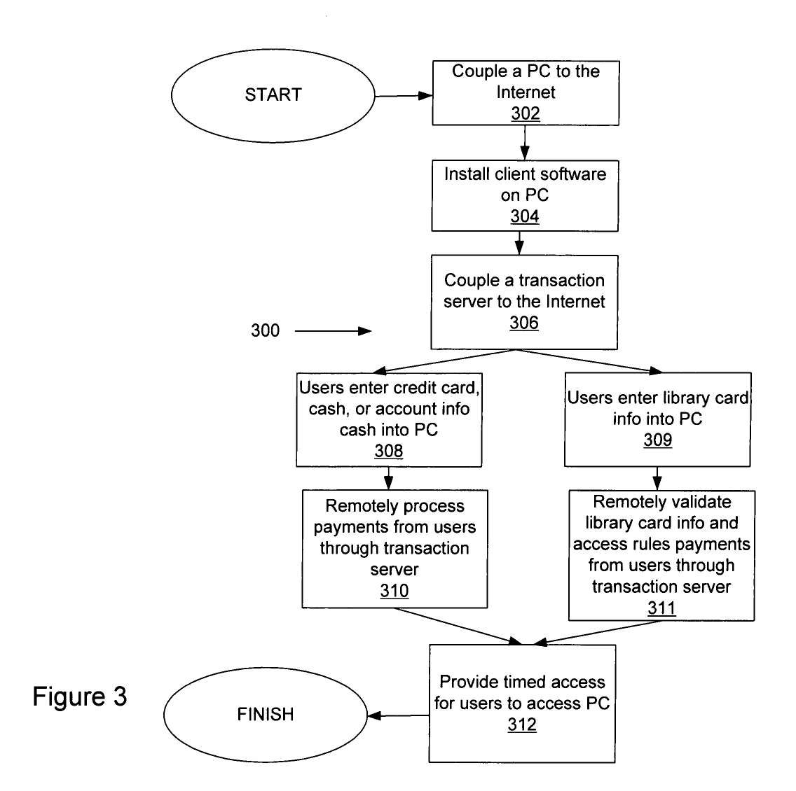

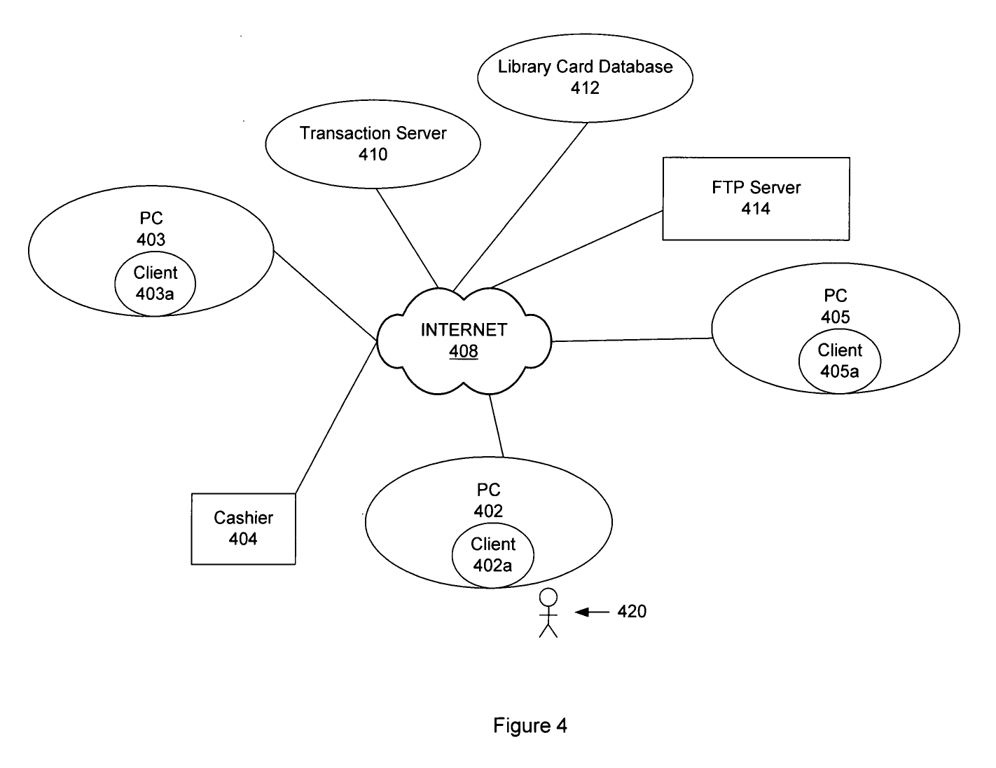

Referring to FIGS. 3 and 4, in another embodiment, there is provided a method for providing metered access to the World Wide Web (“the Web”) at multiple locations, for example small businesses or libraries. The method 300 may use a personal computer 402 (“PC”), connected to the Internet 408 at 302. A software application 402a (“Client”) can be installed on PC 402 at 304. This software 402a allows users 420 to pay for access to the Web 408 or gain access using their library card in libraries.

A transaction server 410 is coupled to the Internet 408 at 306. The user 420 can buy a ticket bearing a login code from the cashier 404, enter a credit card number directly into the client software application 402a, or put cash into a bill acceptor at 308. The bill acceptor may verify the cash or the client 402 communicates with the server application 410 (the “Transaction Server”) via the Web 408 and validates the login code or the credit card at 310. The user 420 is then allowed access to the computer 402 and the Web 408 for the purchased number of minutes at 312. Users 420 can also create and manage reusable accounts that store a certain number of minutes or days. Accounts and login codes are reusable over multiple Web browsing sessions at multiple computer locations 402, 403, 405.

In another embodiment in a library installation, a transaction server 410 is coupled to the Internet 408 at 306. The user 420 can enter their library card number into client 402 at 309. Client 402 communicates with the Library Card Database 412 to validate the library card at 311, for example checking if the user has outstanding library fines. If the card number passes this validation, the Client 402 may secondarily query the Transaction Server 410 to see if this card number is allowed any more access time in the given time period. If so, the user 420 is granted access to the computer at 312.

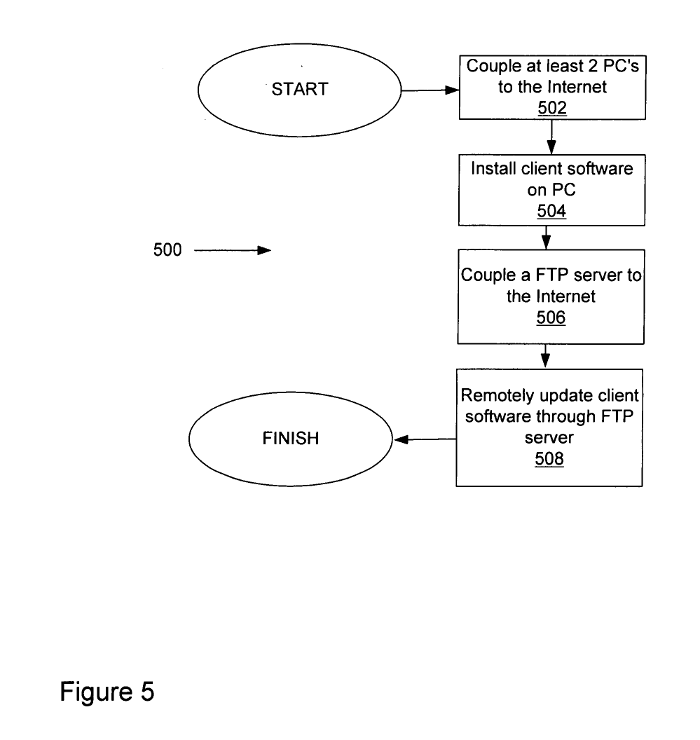

Referring to FIGS. 4 and 5, in another embodiment, there is provided a method for automatically updating the client software 402a, 403a, and 405a and updating the definition of system-wide information related to the service, such as the price per minute for access to the Web, and minimum usage requirements, remotely. Furthermore, it allows for all the client computers 402, 403, and 405 that provide Internet access to be deployed on various private networks behind optional firewalls. At 502, at least two PCs, for example 402, 403, 405, are coupled to the Internet 408. At 504, client software is installed on the PCs, for example 402a, 403a, and 405a. At 506, ftp server 414 is connected to the Internet 408. At 508, ftp server 414 remotely accesses and updates the client software installed on the PCs, for example 402a, 403a, and 405a.

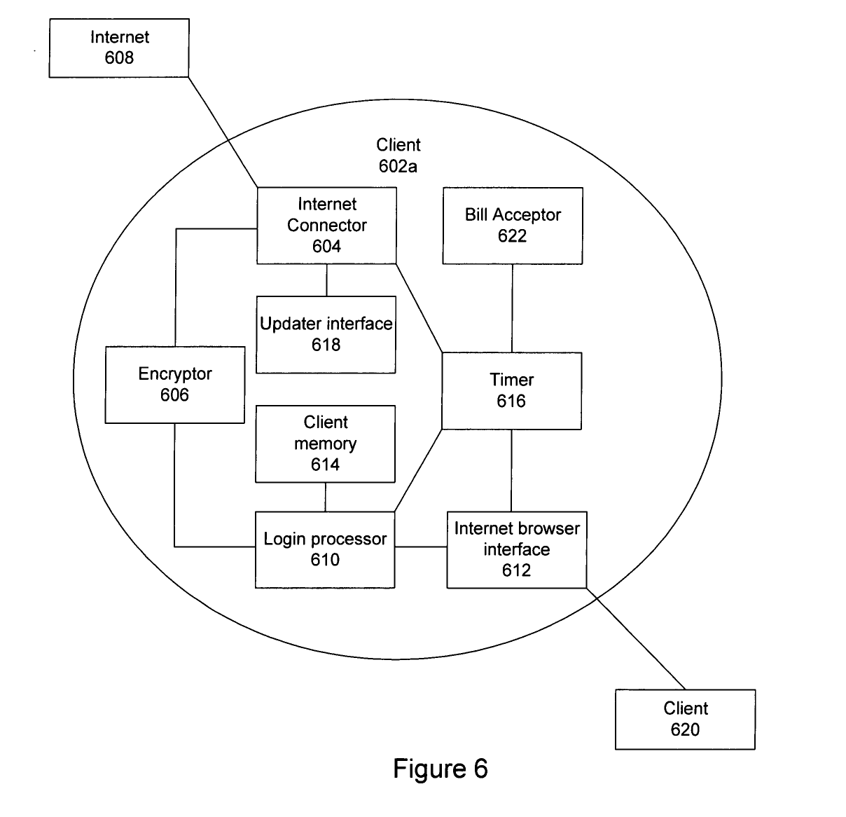

Referring to FIG. 6, in another embodiment, there is provided client 602a which may reside in a computer, for example PC 402, 403, or 405. Client 602a includes Internet connector 604, encryptor 606, Internet 608, login processor 610, Internet browser interface 612, timer 616, updater interface 618, client 620, and bill acceptor 622.

In operation, client 620 accesses the PC by Internet browser interface 612. Client 620 is not able to access Internet 608 until he has met the requirements of client 602a.

Client 620 logs in to client 602a by entering login information into interface 612, which is processed by login processor 610. In one embodiment, client 620 enters his account information which is then passed on to a remote server (not shown). In another embodiment, client 620 enters a login code which was purchased from a cashier at the establishment where the PC is located. In another embodiment, client 620 enters credit card information into interface 612. In another embodiment client 620 inserts cash into bill acceptor 622. In another embodiment, client 620 enters a library card number into interface 612. In another embodiment, interface 612 includes a toolbar which allows a user to launch a web browser and/or other applications.

Client's 620 cash is then verified by bill acceptor 622 or Client's 620 login information may then be encrypted by encryptor 606 and passed to Internet connector 604, to be passed to Internet 608 to be processed by the remote server (not shown). If the remote server validates the login information, for example by processing the credit card, then client 620 is granted access to Internet 608 by login processor 610.

Timer 616 is activated to grant client 620 the allowed or purchased number of minutes or money and/or to record the number of minutes or money the client 620 uses, which can be recorded in the remote server.

In one embodiment, timer 616 periodically updates the remote server on client's 620 use of the Internet, for example providing account information, minutes or money purchased, pages printed, and/or minutes or money used for the client.

When client 620 runs out of minutes or inserted money, or logs out of Internet browser interface 612, timer 616 indicates to interface 612 to stop internet browsing and to return to login screen so that client 620 can purchase more minutes, or so that another user can log on.

In another embodiment, updater interface 618 is provided to update client 602a periodically, for example every night. Updater interface 618 accesses Internet connector 604, which accesses Internet 608, to login to a remote ftp server (not shown), which provides updated client 602a software.

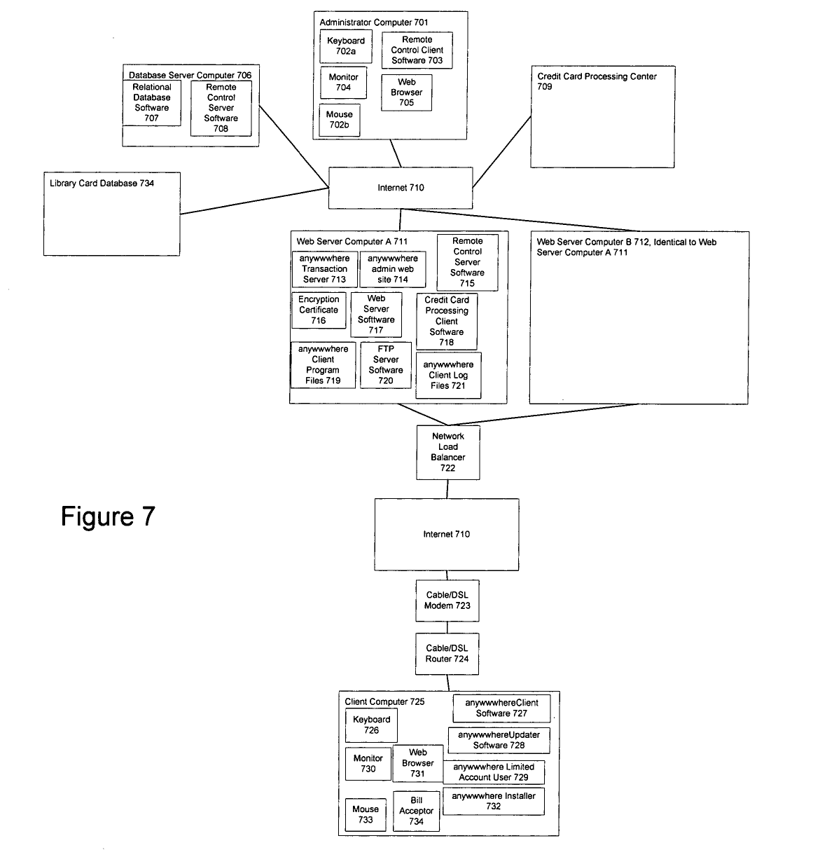

Referring now to FIG. 7, in another embodiment, system 700 for providing metered Internet access is illustrated. System 700 includes Administrator Computer 701. Administrator Computer 701 is used to control Web Server Computers 711 and 712 and Database Server Computer 706.

Administrator Computer 701 hosts Remote Control Client Software 703, which software 703 connects to Remote Control Server Software 708 on Database Server 706 and Remote Control Server Software 715A and 715B on Web Servers 711 and 712. Remote Control Client Software 703 is used to control the functions of Database Server 706 and Web Servers 711 and 712. These functions may include, for example, installing new software, looking at log files, restarting any software running on the server, etc.

Keyboard 702a, Monitor 704, and Mouse 702b may be used by a user to interact with the computer. Web Browser 705 is used to interact with the Admin Web Site 714A and 714B running on the Web Server Computers 711 and 712.

System 700 also includes Database Server Computer 706, which may be located at a hosting provider. Database Server Computer 706 includes Relational Database Software 707, which stores all the records of user accounts, sessions, transactions, vendors and client computer configuration information. Transaction Servers 713A and 713B communicate with Database Server Computer 706 both to store data about transactions, sessions, etc. and to read data to see if a certain action, such as a User login, should be allowed based on the information the user has provided.

Database Server Computer 706 also includes Remote Control Server Software 708, which allows the Remote Control Client Software 703 on the Administrator Computer 701 to connect to the Database Server Computer 706 and gain complete control of all the Database Server Computer's 706 functions.

System 700 also includes Credit Card Processing Center 709, which is a computer run by a credit card processing provider. Credit Card Processing Center 709 accepts credit card processing requests from the Transaction Server Software 713A and 713B running on the Web Server computers 711 and 712, respectively, and responds with an Accepted or Denied response. If the transaction is Accepted, the funds are sent on to a bank account and the Transaction Server 713A or 713B responds to Client Software 727 running on Client Computer 725 with an affirmative response that allows a session to begin.

System 700 also includes Library Card Database 734 which is any number of existing, 3^{rd} party library information systems that provide an HTTP/HTML interface for validating library cards.

System 700 also includes Web Server Computers A 711 and B 712. In one embodiment, Web Server Computers A 711 and B 712 are 2 identical computers that host Web Server Software 717A and 717B. Web Server Software 717A and 717B may be industry standard web server software that listens for messages from Client Computer 725 or Administrator Computer 701.

Web Server Computers A 711 and B 712 also include Transaction Servers 713A and 713B, which may be a web site hosted within the Web Server Software 717A and 717B that processes communications from the Client Software 727. These communications include login requests, account creation/update requests, session status information and account balance information.

Web Server Computers A 711 and B 712 also include Admin Web Sites 714A and 714B, which are a web site hosted within the Web Server Software 717A and 717B that provides administrative functions to the Web Browser 705 on the Administrator Computer 701. These functions include reporting information about the status of the Client Computers 725, vendor information and configuration, Client Computer 725 configuration, creation and maintenance of user accounts and cash cards, and other administrative functions.

Web Server Computers A 711 and B 712 may also include Encryption Certificates 716A and 716B, which are digital certificates purchased from a Certificate Provider, such as Verisign or Thawte. These Certificates 716A and 716B are installed within the Web Server Software 717A and 717B and enable encrypted communication between the Web Server Software 717A and 717B and the Web Browser 705 and/or Client Software 727.

Web Server Computers A 711 and B 712 may also include Credit Card Processing Client Software 718A and 718B, which may be provided by a credit card processing provider and provides communications between Transaction Servers 713A and 713B and Credit Card Processing Center 709.

Web Server Computers A 711 and B 712 may also include FTP Server Software 720A and 720B, which may be Industry standard FTP Server Software that listens for and responds to FTP communication from Updater 728 and Client 727. The Updater 728 communicates with FTP Server Software 720A or 720B to download new versions of Client Software 727 embodied in Client Program Files 719A and 719B. Client Software 727 communicates with FTP Server Software 720A or 720B to download new versions of Updater Software 728 and to send log files 721A and 721B to the database server computer 706.

Web Server Computers A 711 and B 712 also include Client Program Files 719A and 719B, which is the Client Software computer code. The FTP Server Software 720A or 720B sends this code 719A or 719B to Updater 728 to install new versions of Client software 727 on Client Computer 725.

Web Server Computers A 711 and B 712 also include Client Log Files 721A and 721B, which are sent to the FTP Server Software 720A or 720B from Updater Software 728 and Client Software 727. These files 721A and 721B contain any error messages generated by Updater Software 728 or Client Software 727.

System 700 also includes Network Load Balancer 722, which may be an Industry standard network load balancer that balances network traffic between the two or more Web Servers 711 and 712. The load balancer 722 randomly sends requests to one of the Web Servers 711 and 712 to provide redundancy and the ability to handle many simultaneous requests.

System 700 interfaces with Internet 710, which is the worldwide network providing connectivity between one or more Client Computers 725 and Network Load Balancer 722 as well as between Administrative Computer 701, Database Server Computer 706, credit card processing center 709, and Web Server Computers 711 and 712.

System 700 also includes a piece of hardware installed at the customer site that connects the customer's network to the Internet 710, for example, Cable or DSL Modem 723.

System 700 may also includes a piece of hardware that connects the Internet 710 to the customer's network and provides multiple ports to which Client Computers 725 can be connected to the Internet 710. This piece of hardware may be a Cable or DSL Router 724, that connects the Cable/DSL Modem 723 to the customer's network and provides multiple ports to which Client Computers 725 can be connected.

System 700 may also includes Client Computer 725, which may be an industry standard personal computer that sits in the customer's physical location and may be used by users to gain access to the Internet 710.

Client Computer 725 includes Client Software 727, which runs as the operating system shell on the Client Computer 725 and is responsible for providing a Graphical User Interface (GUI) to the User. This interface includes a login screen for starting a session as well as a Toolbar that provides status information during a session.

Client Computer 725 may also includes Updater Software 728, which the Client Software 727 runs every night at a random time to download a new version of the Client 727 Software from the FTP Server 720A or 720B if a newer version is available.

Client Computer 725 may also includes Limited Account User 729, which is an operating system user account that is created on Client Computer 725 when Client 727 is installed. All software programs on the client run under the context of this user. This ensures that users cannot install viruses and/or other software on Client Computer 725 because the limited account does not have rights to do so.

Client Computer 725 may also includes Installer 732, which is software that is run to install initially Client 727 and Updater 728. Installer 732 creates the Limited Account User 729 and configures several operating system settings to configure the Client 727 as the operating system shell.

Client Computer 725 also includes Web Browser 731, which may be Industry standard web browser software that allows the user to browse the Internet 710.

Client Computer 725 may also includes Keyboard 726, Monitor 730, and Mouse 733, which may be industry standard, and allows the user to interact with the Client Computer 725.

Client Computer 725 may also include Bill Acceptor 734, which is a piece of computer hardware used to accept and verify cash. Bill Acceptor 734 alerts Client Software 727 when legitimate cash is inserted. It provides the value of the cash. Client Software 727 then allows access to the Internet.

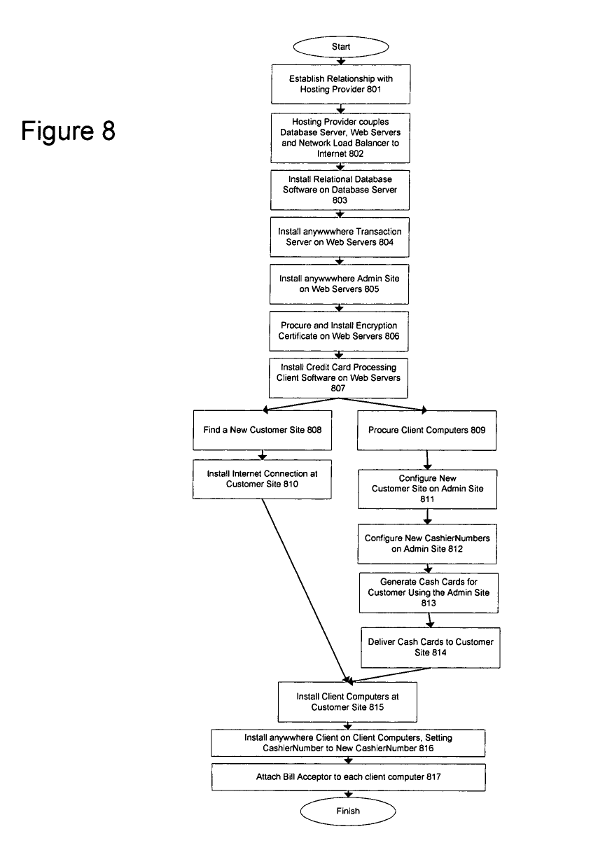

Referring now to FIG. 8, in another embodiment, method 800 for providing metered Internet access is illustrated, for example using system 700.

Method 800 also includes Establish Relationship with Hosting Provider 801. This includes finding a hosting provider that meets the price and feature requirements, and entering into a hosting agreement, and working with them to decide what specific computer hardware will be used.

Method 800 also includes Coupling Servers to the Internet 802. The appropriate number of database and web servers are bought, leased, or otherwise obtained, and connected to the Network Load Balancer. Hosting Provider attaches the network load balancer to the Internet and makes all the computers available for use.

Method 800 also includes Installing Database Software 803. Personnel install relational database software on the Database Server. Personnel configure the relational database software for use.

Method 800 also includes Installing Transaction Server 804. Personnel install the Transaction Server Software on the Web Servers. Personnel connect the Transaction Server to the database server.

Method 800 also includes Installing Admin Site 805. Personnel install the Admin site software on the Web Servers and connect it to the Database Server.

Method 800 also includes Procuring and Installing Encryption Certificate 806. First, purchase a digital certificate from a certification authority. Personnel install the certificate on the Web Servers to enable secure communications (for example, 128 bit) using the Secure Sockets Layer (SSL) and/or the Hypertext Transport Protocol Secure (HTTPS).

Method 800 also includes Installing Credit Card Processing Client Software 807. Personnel install and configure the Credit Card Processing Client Software on the Web Servers to enable real-time credit card processing. Personnel connect the Credit Card Processing Client Software to the credit card processing center.

Method 800 also includes finding a New Customer Site 808. Personnel find a customer site where the client computers will be installed. Personnel negotiate a contract with the new customer.

Method 800 also includes Installing Internet Connection at Customer Site 810. Personnel work with an Internet connectivity provider to install broadband Internet connectivity at the customer site.

Method 800 also includes Procuring Client Computers 809. Personnel purchase industry standard PC's for installation at the customer site.

Method 800 also includes Configuring Customer Site on Admin Site 811. Personnel use the Admin Site to set up the new customer in the database.

Method 800 also includes Configuring New Cashier Numbers on Admin Site 812. Personnel use the Admin Site to configure the new client computer information in the database. Each client computer receives a unique Cashier Number and/or may also receive unique configuration information that tells the Client how to operate, such as limiting payment methods. In library installations, this configuration information includes creation of rules that dictate how long users may access the computers within a given time interval. It also includes how many pages the user may print within a given time interval.

Method 800 also includes Generating Cash Cards 813. Personnel use the Admin Site to generate paper cash cards for sale at the new customer site.

Method 800 also includes Delivering Cash Cards 814. Personnel deliver the cash cards to the customer site and/or to the customers.

Method 800 also includes Installing Client Computers 815. Personnel install Client Computers at the customer site and connect them to the Internet.

Method 800 also includes Installing Client Software 816. Personnel install the Client Software on the Client Computers at the customer site and configure the Cashier Number on each client computer with the unique number created using the Admin Site.

Method 800 may also include attaching Bill Acceptors 817. Personnel attach the Bill Acceptors to each computer where cash payments are to be processed.

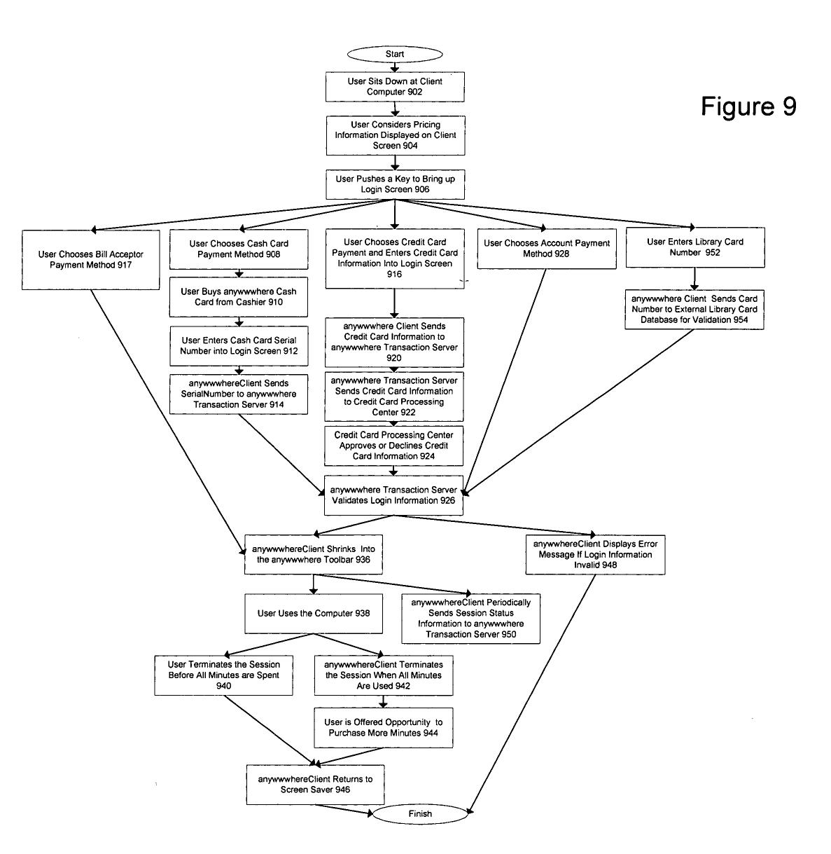

Referring now to FIG. 9, in another embodiment, method 900 for providing metered Internet access is illustrated, for example using system 700.

Method 900 includes User Sits Down at Client Computer 902. The user enters the customer site and sits down at the Client Computer.

Method 900 also includes User Considers Pricing Information 904. The user reads the pricing information on the screen saver of the Client Computer. This information allows the user to make an informed buying decision and can be unique to each client site or computer.

Method 900 also includes User Pushes a Key to Bring Up Login Screen 906. The user pushes any key on the Client Computer keyboard or moves the mouse to dismiss the screensaver and bring up the Client login screen.

Method 900 also includes User Chooses Cash Card Payment Method 908. The user may choose the Cash Payment Method from among the choices displayed on the Client login screen. Depending on client configuration this may be one of 4 choices.

Method 900 may also include User Buys Cash Card from Cashier 910. The user purchases a Cash Card from the customer site cashier to use the Cash Payment Method. The paper card has a serial number on it. The database on the Transaction Server stores a certain number of minutes for that serial number that may be used over multiple sessions.

Method 900 may also include User Enters Cash Card Serial Number into Login Screen 912. The user types the unique Serial Number into the login screen and presses the Start button.

Method 900 may also include Client Sends Serial Number to Transaction Server 914. The client encrypts the serial number and sends it over the Internet to the Transaction Server, for example via HTTPS.

Method 900 may also include User Chooses Credit Card Payment 916. The user chooses the Credit Card Payment method and types credit card information into the login screen. User may also provide account information to create a new account or recharge an existing account. The account will store the purchases minutes or money for later use if they are not all used in the current session. The user presses Start.

Method 900 may also include Client Sends Credit Card Information to Transaction Server 920. The client encrypts the credit card information and sends it to the Transaction Server, for example over the Internet via HTTPS.

Method 900 may also include Transaction Server Sends Credit Card Information to Credit Card Processing Center 922. The Transaction Server encrypts the credit card information and sends it over the Internet, for example via HTTPS, to the credit card processing center.

Method 900 may also include Credit Card Processing Center Approves or Declines Credit Card Information 924. The credit card processing center receives the credit card information, processes it and sends an encrypted response back to the Transaction Server either approving or denying the transaction.

Method 900 may also include User Chooses Account Payment Method 928. The user chooses the account payment method and either reuses their existing account or creates a new account.

Method 900 may also include User Enters Library Card Number 952 when the system is installed at a public library.

Method 900 may also include Client Sends Library Card Number to External Library Card Database for Validation 954. The external database returns a reply indicating if the library card is valid and if it has outstanding fines. If fines are above a certain amount as defined in the admin site, then access to the computer may be denied.

Method 900 also includes Transaction Server Validates Login Information 926. The Transaction Server receives the login information, for example via HTTPS, and validates it against the information in the database. If all the login information is valid and the cash card or account has minutes remaining, the server returns an encrypted, positive response to the client. If anything is wrong with the login information, the server sends an encrypted, negative response to the client that includes a human-readable, friendly error message informing the user of the problem.

Method 900 may also include User Chooses Bill Acceptor Payment Method 917. The user inserts cash into the bill acceptor. The user inserts cash into the Bill Acceptor, which verifies its legitimacy and sends a response to the client software. If the cash is successfully stacked in the Bill Acceptor, the client credits the user. The user may or may not provide account information to create a new account or recharge an existing account. The account will store the purchased minutes or money for later use if they are not all used in the current session. The user presses Start.

Method 900 also includes Client Shrinks into the Toolbar 936. After a successful login, the Login Screen disappears and is replaced by the Toolbar. The Toolbar displays how much session time remains and counts it down, for example on a second by second, or minute by minute basis. The Toolbar may also display buttons for starting applications on the Client Computer such as the Web Browser.

Method 900 also includes User Uses the Computer 938. The user may browse the Internet using a Web Browser, use office productivity software, play video games, use instant messaging software, or any other software installed on the computer and configured as a button on the configurable Toolbar. In one embodiment, a method is provided for offering metered computer access for a user to access the internet, play games, use office software, etc., which is monitored by a remote computer.

Method 900 may also include User Terminates the Session 940. The Toolbar includes a Quit button that allows the user to terminate his session before he has used all of his minutes. Cash Card and Account minutes can be used over multiple sessions.

Method 900 may also include Client Terminates the Session 942. If all the minutes available for a Cash Card, Account or One-Time Credit Card session are used up, then the client terminates the session.

Method 900 may also include User is Offered Opportunity to Buy More Minutes 944. If the session is a One-Time Credit Card session or a Cash Card session, then the user is offered the chance to purchase another Cash Card or use the credit card to buy more minutes.

Method 900 also includes Client Returns to Screen Saver 946. If the user chooses not to purchase more minutes, then the client maximizes back to the entire screen size and presents the screen saver that displays the pricing information.

Method 900 may also include Client Displays Error Message 948. If the login information is invalid for any reason, the-server returns an error code and friendly error message describing the problem. The client displays the error message to use user.

Method 900 may also include Client Periodically Sends Session Status Information to Transaction Server 950. During a session, the client periodically sends session status information, including the number of minutes used, to the Transaction Server, which logs the information and deducts it from the user's Account or Cash Card.

In another embodiment, there is provided a Client software application that is installed on a PC, and the PC has a connection to the Internet. The Client software installed on the PC presents a user with the opportunity to enter credit card information, a login code, or cash. The Client sends the credit card information or code to the Transaction Server over the Web. The server processes the code or credit card in real time and returns a response to the Client indicating whether or not the card or code is valid. Based on this response code, the Client application will allow the user access to the PC.

In another embodiment, the client provides a toolbar for the user during the session that displays the number of minutes or amount of money remaining in the session and provides buttons for opening applications such as word processors, Web browsers, etc. The toolbar may also provide a Quit button for ending the session.

In another embodiment, the client intercepts all print job submissions on the client computer and presents the user the opportunity to deduct time or money from the current session to purchase the submitted number of pages. The user may also enter a serial number code containing a stored number of print pages. The client interrogates the printing system to learn the number of pages that have been submitted and charges the user per page.

In another embodiment, the client intercepts all print job submissions on the client computer and allows the user to print a number of pages defined by configuration rules set for the given location on the admin site. The configuration rules allow a certain number of pages to be printed in a certain time span. This may be used in library situations.

In another embodiment, the Client software provides the user the opportunity to choose the language in which they would like to see the display. The Client changes all the text in its display to the chosen language.

In another embodiment, the Client software provides metered web access from behind firewalls to small businesses and/or libraries. The Client software may use standard Web Services protocols as defined by the World Wide Web Consortium (W3C) to integrate with a transaction server, which in turn uses these same protocols to integrate with a credit card processing service provider to process credit cards directly and securely in real time.

In another embodiment, the Client software integrates with a Bill Acceptor using the RS232 serial protocol. The Client software monitors the Bill Acceptor and tallies any cash inserted into it.

In another embodiment the client integrates with an electronic credit card reader using the USB HID protocol or the RS232 serial protocol. The client receives the card information from the reader and submits it to the Transaction Server for processing.

In another embodiment, the Client software may be run as just a print monitor. In this mode it does not present a login interface or meter web access, but it does intercept all print jobs and require that a print code be entered before the job is printed.

In another embodiment, the Client software may be configured to accept reservations. In this mode, the user is presented with an interface for choosing a date, time and computer to reserve. The client sends this information and the user's library card number or login name to the Transaction Server where it is stored. The given user will be the only user allowed to login on the reserved time on the reserved machine. Librarians may also use the admin site to create, edit and delete reservations.

In another embodiment, the Client software may be configured to perform MOD10 (also known as the Luhn Algorithm) validation on library card numbers to validate their validity.

In another embodiment, the Client software may be configured to allow library users to create login names and passwords that are linked to their library card number. This prevents the user from having to remember their library card number to login to the Client.

In another embodiment the Client software may be configured to validate library card numbers against an External Library Card Database. The Client software accepts several configuration parameters that specify how the Client should use the HTTP and HTML protocols to communicate with the External Library Card Database. Depending on its configuration, the Client software can listen for any number of affirmative or negative responses in the returned HTML content. The Client software can also parse the returned HTML content for library fine balance information. The Client uses all of this information to decide whether or not to grant the user access to the PC. If any negative responses are matched, no affirmative responses are matched, or if the fine balance exceeds the configured limit then the Client software will deny the user access to the PC. If no negative responses are matched or any affirmative responses are matched and the fine balance does not exceed the configured limit, then the Client software will grant the user access to the PC. Librarians can configure any of these parameters using the anywwwhere Admin Site.

In another embodiment, there is provided a method for updating the Client software and updating the definition of system-wide information related to the service, such as the price per minute for access to the Web and minimum usage requirements, remotely. In this way, the PC's providing the metered Web access do not require service visits for either upgrades or service policy changes. In one embodiment, this updating may be done using an Update Server and/or an Updater.

In another embodiment, the client is provided with automatic remote software updates. The client includes a software application that connects to a FTP (File Transfer Protocol) server on a nightly basis. If a new version of the Client exists on this server, the updater downloads the new version and installs it on the local PC. In one embodiment, the updater runs at a random time so that multiple client machines do not all attempt to download the new version at once and the load on the FTP server is spread out over the night. In addition to downloading the software, the updater may also separately download configuration settings such as the price that should be charged per minute. This automatic distribution of software and configuration settings allows the network to operate without any effort from the proprietors. The client updater and the updater server allow for configuration such that each client machine can have a unique set of configuration settings if so desired.

In another embodiment, there is provided a Transaction Server, which processes all logins on behalf of the clients and stores usage information in a centralized database. The transaction server may include a web site where proprietors or librarians can login and see the activity associated with the client machines at their locations. The transaction server may also provide automated invoicing of proprietors and automated creation of paper login code tickets.

In another embodiment, there is provided a Transaction Server. The Transaction server provides a library of Web Services methods that can be called by the client over an encrypted connection to do things such as login, update the remaining minutes in a session, change a password, add minutes or days to an account, or check the status of a login code or account. The Transaction server may run in a connectionless mode such that interruptions in connectivity between it and the clients have only limited effects. In one embodiment, a user can continue using a client machine even though the Transaction server may be unavailable.

The Transaction server may store all of the login information in a centralized repository, for example a database, that is organized by proprietor location. The Transaction server may offer a web site interface that proprietors and/or librarians can use to run various reports on the usage of the machines at their locations. The site governs access to this information such that a proprietor or librarian can only see the data associated with their location. The Transaction server may also generate invoices and login code tickets in a convenient format, for example Portable Document Format (pdf), for delivery to proprietors.

In another embodiment, the Transaction server provides a web interface to librarians for managing a set of configurable rules that govern how users may access computers at their location. The rules may include setting amounts of allowed minutes and allowed pages over the course of two different intervals. The rules may also include how long session information should be retained in the centralized database. The rules may also contain daily library open and close times. User sessions are not allowed to occur when the library is closed.

In one embodiment of use, when the user quits the session or runs out of time, he is given the opportunity to purchase more minutes. If he does not, then the client application may lock the PC down in preparation for the next customer and displays the login screen again. In one embodiment, the process is completed without any assistance from a cashier or other personnel at the proprietor location.

In use, the user may be initially presented with a login screen offering five different ways to login: (1) Login Code—The user can purchase a paper ticket from the cashier that has a login code and is good for a certain number of minutes. (2) Account—The user can enter their existing account information and gain access to the PC. (3) Credit Card—The user can enter their credit card number and optionally provide account information to create a new account or recharge an existing account. If no account information is provided, the user is granted one time access to the PC for a certain number of minutes. If account information is provided, the account is created or updated and the user is granted access to the PC based on the new account balance. (4) Cash/Bill Acceptor—The user can insert cash into the bill acceptor. The bill acceptor will validate the cash and inform the client software of the cash balance. The user can optionally provide account information. If no account information is provided, the user is granted one time access to the PC for a certain number of minutes. If account information is provided, the account is created or updated and the user is granted access to the PC based on the new account balance. (5) Library Login—The user can provide their library card number and/or login name. The client will validate that information using the Transaction server. It may also validate it using the MOD10 algorithm or an External Library Card Database. If the information is valid, the client will grant the user access to the PC for the length of time configured in the rules on the Transaction Server.

In one embodiment, the login approaches use a Web Services call to pass the provided login information to the Transaction server. The Transaction server may validate the login code, account information or credit card information in real time and reply to the client. All Web Services communications between the client and the Transaction server may be encrypted using the Secure Sockets Layer (SSL) protocol.

Further, the client may obtain configuration settings from a transaction server, for example in real time. Individual login styles can be enabled or disabled. Any of the prices can be changed. The graphics of the interface can be changed if a proprietor or librarian wants to use their own brand identity. Many other settings that govern the behavior of the client can also be changed in the configuration settings.

The above-described embodiments of the present disclosure include a number of reference numerals provided to aid in the understanding of the disclosed devices and methods. Although the same or similar reference numerals have been used in multiple figures and for multiple embodiments for the sake of convenience, it should not be assumed that the same reference numeral refers to the same element or that similarly numbered elements are the same element in each of the figures and embodiments.

The above description of the embodiments according to the disclosure are merely examples, and, thus, variations that do not depart from the gist of the disclosure are intended to be within its scope. Such variations are not to be regarded as a departure from the spirit and scope of the invention. In addition, the various embodiments discussed above are used to illustrate the components and functioning of the systems and methods, and should not be used to interpret the scope of the claims set forth below.

1. A system for providing internet access comprising:
a computer located in a first location connected to a network;
a transaction server located in a second location removed from the first location connected to the network;
wherein the transaction server is adapted to selectively provide Internet access to the computer.

2. A system for providing metered Internet access comprising:
an administrator computer connected to the Internet;
a database server computer connected to the Internet;
a credit card processing center connected to the Internet;
at least one web server computer connected to the Internet; and
a client computer connected to the Internet.

3. The system of claim 2, further comprising a network load balancer connected to the least one web server computer.

4. A method of providing metered Internet access, comprising:
coupling a database server and a web server to the Internet;
installing a database on the database server;
installing a transaction server on the web server;
connecting a client computer to the Internet;
installing client software on the client computer, so the client computer is adapted to communicate with the transaction server.

5. A method of providing metered Internet access, comprising:
a user sits down at a client computer;
the user chooses a payment method;
the user's payment method is validated by a remote transaction server; and
the user is provided access to the Internet.

6. A method of regulating the use of PCs in a library setting, comprising:
a user sits down at a client computer;
the user enters library card or login name information;
the client software validates the information using the MOD10 algorithm, an external library card database, or a transaction server; and
the user is allowed access to the computer for a length time determined by the rules as configured on the transaction server.
